(19) United States
(12) Patent Application Publication
(10) Pub. No.: US 2023/0055559 A1
(43) Pub. Date: Feb. 23, 2023

(54) METHODS AND SYSTEMS FOR ESTIMATING A VALUE OF A FUTURE VEHICLE

(71) Applicant: Capital One Services, LLC, McLean, VA (US)

(72) Inventors: Chih-Hsiang CHOW, Coppell, TX (US); Elizabeth FURLAN, Plano, TX (US); Steven DANG, Bellevue, WA (US)

(73) Assignee: Capital One Services, LLC, McLean, VA (US)

(21) Appl. No.: 17/407,781

(22) Filed: Aug. 20, 2021

(51) Int. Cl. G06Q 30/02; G07C 5/00; G06T 7/00; G06K 9/62

(52) U.S. Cl. CPC G06Q 30/0278; G07C 5/008; G06Q 30/0206; G06T 7/0002; G06K 9/627; G06Q 30/018

(57) ABSTRACT

Disclosed are methods, systems, and non-transitory computer-readable medium for estimating a value of a future vehicle. For instance, the method may include receiving a request for a target vehicle value estimate, obtaining an optical scan of a vehicle, generating a vehicle reference, the mileage of the vehicle, and the feature set of the vehicle, comparing the optical scan to the vehicle reference to identify one or more differences between the surfaces of the vehicle and corresponding surfaces of the vehicle reference that are indicative of damage or wear, and evaluating a relative condition of the vehicle based on those differences. The method may further include retrieving a target vehicle reference, generating a projection of a future condition of the target vehicle based on the relative condition of the vehicle, retrieving third-party vehicle records relevant to the target vehicle, and determining an estimated future value of the target vehicle.

### TECHNICAL FIELD

Various embodiments of the present disclosure relate generally to methods and systems for estimating a value of a future vehicle and, more particularly, to methods and systems for estimating a value of a future vehicle based on the condition of a current vehicle.

### BACKGROUND

Vehicles are often among the most expensive items a person buys and sells, but few people do so often enough to have expertise in determining the future value, or even the present value of a vehicle they are selling or buying. The internet provides some basic valuation resources for determining the current value of a vehicle, such as the Kelley Blue Book, however these vehicle values are estimated based on relatively basic information, such as year, make, model, mileage, and general condition of the vehicle, and only relate to current values. The general condition of the vehicle may allow for an estimated current value, however a more accurate valuation would include a more specific determination of an interior condition, exterior condition, and mechanical condition. While it is possible to gain such a more specific determination of the vehicle's present condition via an appropriate inspection, the future condition of the vehicle is more difficult to project. A potential buyer or seller may benefit from a future value projection that takes into account the vehicle's depreciation based on the owner's projected use of the vehicle.

The present disclosure is directed to addressing one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure methods, systems, and non-transitory computer-readable media are disclosed for estimating a value of a future vehicle. Each of the examples disclosed herein may include one or more of the features described in connection with any of the other disclosed examples.

For instance, a method may include receiving a request for a target vehicle value estimate for a target vehicle that includes a mileage of a first vehicle and a feature set of the first vehicle; obtaining an optical scan corresponding to the first vehicle, wherein the optical scan is performed by an optical sensor and includes a digital surface representation of at least one surface of the first vehicle; generating a first vehicle reference based on at least an identification of the first vehicle, the mileage of the first vehicle, and the feature set of the first vehicle; comparing the optical scan to the first vehicle reference to identify one or more differences between the at least one surface of the first vehicle and a corresponding surface of the first vehicle reference that are indicative of damage or wear; and evaluating a relative condition of the first vehicle at least partly based on the one or more differences indicative of damage or wear. The method may further include retrieving a target vehicle reference, wherein the target vehicle reference corresponds to the target vehicle identified in the request for the target vehicle value estimate; generating, based at least in part on the relative condition of the first vehicle, a projection of a future condition of the target vehicle; retrieving third-party vehicle records relevant to the target vehicle; and determining, based on the third-party vehicle records, an estimated future value of the target vehicle.

A system for estimating a value of a future vehicle may include a processor; and a memory storing instructions that, when executed by the processor, cause the processor to perform operations. The operations may include receiving a request for a target vehicle value estimate for a target vehicle, wherein the request includes a mileage of a first vehicle and a feature set of the first vehicle; obtaining an optical scan corresponding to the first vehicle, wherein the optical scan is performed by an optical sensor and includes a digital surface representation of at least one surface of the first vehicle; generating a first vehicle reference based on at least an identification of the first vehicle, the mileage of the first vehicle, and the feature set of the first vehicle; comparing the optical scan to the first vehicle reference to identify one or more differences between the at least one surface of the first vehicle and a corresponding surface of the first vehicle reference that are indicative of damage or wear; and at least partly based on the one or more differences indicative of damage or wear, evaluating a relative condition of the first vehicle. The operations may further include retrieving a target vehicle reference, wherein the target vehicle reference corresponds to the target vehicle identified in the request for the target vehicle value estimate; generating, based at least in part on the relative condition of the first vehicle, a projection of a future condition of the target vehicle; retrieving third-party vehicle records relevant to the target vehicle; and determining, based on the third-party vehicle records, an estimated future value of the target vehicle.

A non-transitory computer-readable medium may store instructions that, when executed by a processor, cause the processor to perform a method. The method may include receiving a request for a target vehicle value estimate for a target vehicle, wherein the request includes a mileage of a first vehicle and a feature set of the first vehicle; providing scan instructions to a user device to guide a user in performing an optical scan of the first vehicle; obtaining the optical scan corresponding to the first vehicle, wherein the optical scan is performed by an optical sensor and includes a digital surface representation of at least one surface of the first vehicle; generating a first vehicle reference based on at least an identification of the first vehicle, the mileage of the first vehicle, the feature set of the first vehicle, and at least one reference scan of a first reference vehicle; comparing the optical scan to the first vehicle reference to identify one or more differences between the at least one surface of the first vehicle and a corresponding surface of the first vehicle reference that are indicative of damage or wear; at least partly based on the one or more differences indicative of damage or wear, evaluating a relative condition of the first vehicle. The method may further include retrieving a target vehicle reference, wherein the target vehicle reference corresponds to the target vehicle identified in the request for the target vehicle value estimate; generating, based at least in part on the relative condition of the first vehicle, a projection of a future condition of the target vehicle; retrieving third-party vehicle records relevant to the target vehicle; and determining, based on the third-party vehicle records, an estimated future value of the target vehicle.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary block diagram of a system environment for determining an estimated future value of a vehicle, according to one or more embodiments.

FIG. 2 depicts a flowchart of an exemplary process for determining an estimated future value of a vehicle, according to one or more embodiments.

FIG. 3 depicts a flowchart of an exemplary process for obtaining an optical scan having sufficient detail, according to one or more embodiments.

FIGS. 4A-4C depict exemplary user interfaces that may provide prompts to a user on a user device, according to one or more embodiments.

FIG. 5 depicts an example of a computing device, according to aspects of the present disclosure.

### DETAILED DESCRIPTION OF EMBODIMENTS

The terminology used in this disclosure is to be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “computer system” generally encompasses any device or combination of devices, each device having at least one processor that executes instructions from a memory medium. Additionally, a computer system may be included as a part of another computer system.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially,” “approximately,” “about,” and “generally,” are used to indicate a possible variation of ±10% of a stated or understood value.

In general, the present disclosure provides methods and systems for estimating a value of a future vehicle. As will be discussed in greater detail herein, existing techniques may be improved with the methods and systems of the present disclosure. In particular, a method according to the present disclosure may begin with a user submitting a request for a future valuation of a target vehicle, for example, via a website, mobile application, or other system interface. This request may include information about the user's current vehicle, the target vehicle, or some combination thereof. The method may proceed to direct a user to scan the user's current vehicle, and compare the scan to a vehicle reference in order to evaluate the relative condition of the user's current vehicle. This comparison may be used to predict the kind of wear and tear the user puts on his vehicle. For example, if the comparison reflects a user who has dents and scrapes on the bumpers of the vehicle, it may suggest that the vehicle is often parked on the street in a city.

The observed use pattern may then be applied to a target vehicle that the user is considering purchasing, and project the condition of the target vehicle in the future, based on being used similarly to the user's current vehicle. For example, if the user's current vehicle is often parked on the street in a city, as evidenced by the dents and scrapes on the bumpers, and the target vehicle may be used under similar conditions, the target vehicle's projected future condition can reflect this use. The projected future condition of the target vehicle may then be used, for example, in concert with vehicle records relevant to the target vehicle, to determine an estimated future value for the target vehicle after the user owns it for some period of time. This may provide the user with an improved understanding of how depreciation due to the user's particular use patterns may impact the future value of a vehicle, and may enable the user to appreciate the cost of ownership of the target vehicle. This improved understanding may allow the user to, for example, budget for repairs or decide to adjust their use patterns (e.g., finding off-street parking).

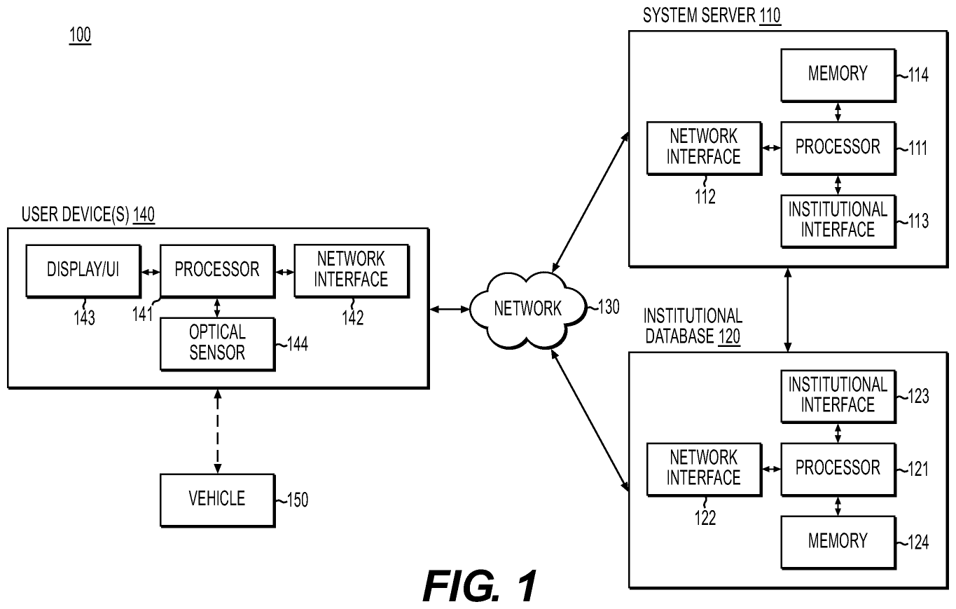

FIG. 1 depicts an exemplary system environment 100 that may be utilized with techniques presented herein. For example, the system environment 100 may include a system server 110, an institutional database 120, a network 130, user device(s) 140 (hereinafter referred to as “user device 140” for ease of reference), and a current vehicle 150. System server 110 may collect one or more optical scans and vehicle references, determine an estimated future value of a target vehicle based on one or more optical scans of a current vehicle, and provide the estimated future value of the target vehicle to the user device 140.

System server 110 may include a processor 111 to execute instructions, and a network interface 112 with which to communicate with other elements in system environment 100. System server 110 may also include an institutional interface 113, in addition to or in combination with network interface 112, which may enable system server 110 to communicate with a secure institutional database 120. Information, including instructions to be executed by processor 111, may be stored in memory 114.

Institutional database 120 may be, for example, a secure server or other system associated with an institution and on which information, such as vehicle references and interaction data, may be stored. Institutional database 120 may include a processor 121 which may execute instructions stored in a memory 124 in order to allow institutional database 120 to receive and store vehicle data received via a network interface 122 and/or an institutional interface 123, and may also allow institutional database 120 to respond to inquiries for information, such as requests for vehicle references. In some embodiments, institutional database 120 may be integral with system server 110, and/or functionally integral with system server 110.

Network interface 112 of system server 110 and network interface 122 of institutional database 120 may communicate with each other and/or other elements of the system environment 100 via network 130. Network 130 may be implemented as, for example, the Internet, a wireless network, a wired network (e.g., Ethernet), a local area network (LAN), a Wide Area Network (WANs), Bluetooth, Near Field Communication (NFC), or any other type of network or combination of networks that provides communications between one or more components of the system environment 100. In some embodiments, the network 130 may be implemented using a suitable communication protocol or combination of protocols such as a wired or wireless Internet connection in combination with a cellular data network.

Network 130 may provide system server 110 and institutional database 120 with a connection to one or more user devices 140. User device 140 can be, for example, a computer, telephone, tablet, or other device that can provide a user with access to system server 110, for example, via a website or mobile application. User device 140 may include a processor 141, a network interface 142 for communicating with other elements in system environment 100, a display/user interface (UI) 143 to receive input from and/or provide information to, the user, and an optical sensor 144.

Display/UI 143 can be in communication with processor 141 to provide the user of the device with instructions and prompts to request information, as well as to allow the user to provide the requested information to the system server 110. In some embodiments in accordance with the present disclosure, display/UI 143 may include one or more monitors, touchscreen panels, keyboards, keypads, mice/trackpads, and/or other suitable devices for displaying information to, and/or for receiving inputs from, users of user device 140. User device 140 may be capable of allowing a user to, for example and not limitation, submit a request for a target vehicle value estimate, conduct an optical scan of the user's vehicle 150 using, e.g., the optical sensor 144, and receive an estimated future value of the target vehicle via display/UI 143.

The optical sensor 144 may be, for example, a camera or a Lidar system capable of capturing images or other representations of the contours of a surface to be scanned. The optical sensor 144 may perform an optical scan, and the resulting scan may include optical scan data that represents one or more surfaces of vehicle 150, and may take the form of an image(s), model, or other digital surface representation. In some embodiments, the interior and exterior surfaces of vehicle 150 are represented in the optical scan data, either together as a single model, or separately as different images, models, or other digital representations.

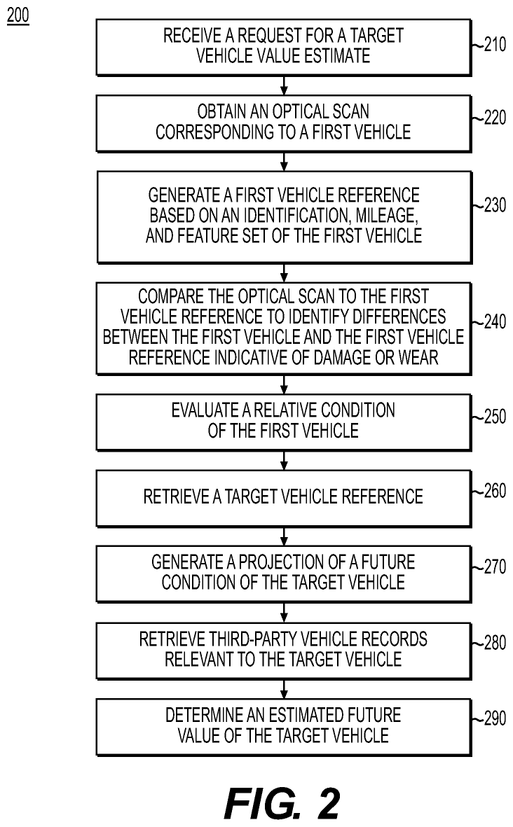

FIG. 2 depicts a flowchart illustrating a method 200 for estimating a value of a future vehicle, according to one or more embodiments of the present disclosure. The method may be performed by a system in accordance with the present disclosure, including one or more of the devices that comprise the system environment 100.

Method 200 may begin at step 210, with the receipt of a request for a target vehicle value estimate, for example, by system server 110. The request may be transmitted by user device 140 responsive to a user input on the user device 140, and may include information regarding the vehicle to be scanned and/or information regarding the target vehicle. In some embodiments, user device 140 collects information from the user via a website or mobile application based on user inputs and/or user data (e.g., a user profile, user preferences, user history, etc.), and then transmits the request, including the collected information, to system server 110 via network 130. One of skill in the art would recognize that the user data may already be stored on system server 110. For example, the website or mobile application may request information regarding vehicle 150, for example, the year, make, model, trim level, mileage, feature set, the date the vehicle was acquired, and the mileage on the vehicle when it was acquired, and may request demographic or other information about the user, such as the user's name, age, and home address or zip code. The date the vehicle was acquired, and the mileage on the vehicle when it was acquired may be used by system server 110 to determine a duration and distance of use by the user, in the event that some of the use of vehicle 150 was made by a previous owner (e.g., when the user acquired vehicle 150 as a used vehicle). Some embodiments may request additional information regarding how, when, why, and where vehicle 150 has been or is typically used. At this stage, the website or mobile application may request similar information regarding the target vehicle (e.g., the year, make, model, trim level, mileage, features) as well as how far into the future the user would like to project the car's value, however some embodiments may collect this information at a later time.

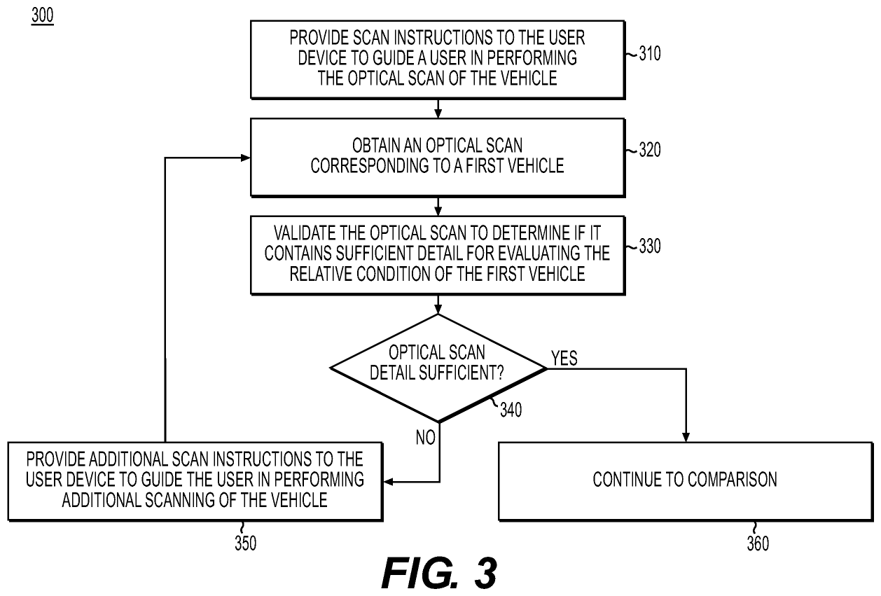

Once the request is received, at step 220, system server 110 can obtain an optical scan of vehicle 150. This scan may be obtained by, for example, instructing a user to perform a scan and/or by retrieving a previously performed scan. When the optical scan is to be conducted by the user, instructions may be provided on display/UI 143 to guide the user in directing optical sensor 144 around vehicle 150 to appropriately scan the surfaces of vehicle 150. The user device 140 may then transit the optical scan to the system server 110. The optical scan obtained should include enough detail to allow for the subsequent comparison(s) to determine the relative condition of vehicle 150. An exemplary process for obtaining an optical scan having sufficient detail will be discussed with reference to FIG. 3.

As seen in FIG. 3, method 300 may begin, at step 310, with instructions being provided to the user via user device 140 in order to guide the user in performing the scan of vehicle 150. The optical scans may be conducted in a single step, or in multiple steps, and the instructions may include visual aids and/or detailed feedback in order to assist the user in performing an appropriately detailed and accurate optical scan. Once the instructions have been provided, and the scan has been performed, at step 320, the optical scan data can be received by, for example, system server 110.

At step 330, the received optical scan data can be reviewed to assess whether or not it contains sufficient detail with which to evaluate the relative condition of vehicle 150. The validation process may proceed to compare the optical scan data to predetermined thresholds for detail and/or for the presence of important features/characteristics of vehicle 150. This validation may be accomplished by, for example, sampling the optical scan data for clarity and/or resolution, determining whether or not certain exemplary details are present in the optical scan data, and/or reviewing the optical scan data for visual artifacts. For example, sampling the optical scan data for clarity and/or resolution may be accomplished by determining that a sampled portion of the optical scan data has an image resolution above a predetermined threshold. While determining whether or not certain exemplary details are present may involve detecting particular parts within the scanned vehicle using image recognition processes and determining whether or not there are an expected number of parts, such as whether there are four wheels visible in the exterior scan. In some embodiments, the optical scan data may be reviewed for visual artifacts, for example by determining if there are regions of glare or shadow present by evaluating characteristics such as contrast gradients between portions of the optical scan that exceed a predetermined threshold).

In the event that the validation process indicates that the optical scan lacks sufficient detail (step 340: No), at step 350, additional instructions may be provided to the user via user device 140 in order to allow the user to correct any issues with the optical scan previously performed by performing additional partial or total scanning of vehicle 150. In some embodiments, these instructions may be similar to those provided at step 310. The additional instructions may also be more particular than those previously provided at step 310, as there may be a specific issue identified with the scan (e.g., not scanning a particular portion of the vehicle). In situations in which the optical scan does not contain sufficient detail due to a specific and identified issue, the additional scan instructions may direct the user to address the identified issue, without re-performing the entire scan. For example, a scan may be determined to be sufficiently detailed with respect to the exterior surfaces of vehicle 150, but may not be detailed enough with respect to the interior surfaces. In situations such as these, the additional instructions may include only the interior scan instructions. Generally, the additional instructions may direct the user to perform at least partial scans of vehicle 150. In particular, the additional instructions may indicate, for the partial scans of vehicle 150, particular scans of views, ranges, and regions of the vehicle 150. Once the additional instructions have been provided, and the scan has been partially or completely re-performed, the method may proceed to step 320, the optical scan data can be re-obtained and re-validated. In the event that the validation process indicates that the optical scan detail is sufficient (step 340: Yes), at step 360, the method may proceed to the next step of exemplary method 200.

Alternatively, the user device 140 may perform the validation process, in whole or in part, and determine the additional instructions to be provided to the user. In this case, bandwidth utilization may be reduced.

Returning to FIG. 2, the method may continue to step 230 and generate a vehicle reference for vehicle 150 based on an identification of the vehicle, and other vehicle information that may include one or more of the mileage, features, and options. In some embodiments, this information may be included in the request for a target vehicle value estimate. System server 110 may verify and/or collect information about vehicle 150 by obtaining it from the request for a target vehicle value estimate, the optical scan data, a subsequent prompt to the user, or a combination of those methods. In some embodiments, identification of the first vehicle may be determined and/or verified by comparing one or more features from the optical scan with a database of vehicle information. Based on the comparison, the first vehicle may be identified by determining the closest match to the optical scan and/or by locating features such as badging, branding, or other distinguishing features. For example, system server may locate a badge on a portion of the exterior of the vehicle, and search the database for vehicles having the same or similar badging.

Once vehicle 150 has been identified, system server 110 may generate a vehicle reference for vehicle 150. The vehicle reference may be generated based on data from the user, the optical scan, and/or the institutional database 120. The vehicle reference may include data that is itself an optical reference scan of a version of vehicle 150 (e.g., a reference vehicle of the same make, model, and year), or is similar to the data in the optical scan of vehicle 150 (e.g., a machine generated scan or model).

Having both the optical scan of vehicle 150 and the vehicle reference, at step 240, system server 110 may compare the optical scan to the vehicle reference to identify differences such as dents, tears, rust, or other such differences that may be indicative of damage and/or wear of vehicle 150. The identified differences may include data indicating location, size, quality, and/or severity of the damage and/or wear. In some embodiments, this comparison may be conducted directly by system server 110 or institutional database 120, or may be conducted by another element, such as a machine learning system. The comparison may involve comparisons of the exterior surfaces, interior surfaces, and/or mechanical characteristics, with differences potentially being the result of normal use and wear (e.g., tire tread wear, wearing of the interior surfaces such as the seats) or accident damage (e.g., from collisions, weather damage such as hail). For instance, system server 110 may step through image frames and match the angle of the vehicle to one or more similar images in the vehicle reference. In some embodiments, a machine learning system may be used to create a machine learning model to model the ways in which a vehicle scan and a vehicle reference may differ. Such a model may be trained, for example, on a series of vehicle scans having known differences, such that the model is able to recognize common differences such as dents, chipped paint, rust, interior discoloration, and the like.

As used herein, a “machine learning model” is a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistic regression, random forest, gradient boosted machine (GBM), deep learning, and/or a deep neural network. Supervised and/or unsupervised training may be employed. For example, supervised learning may include providing training data and labels corresponding to the training data. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

Then, at step 250, based on the differences identified between vehicle 150 and the vehicle reference, at step 250, system server 110 may evaluate the relative condition of vehicle 150. To evaluate the relative condition of vehicle 150, the system server 110 may use an evaluation model. The evaluation model may obtain the differences and determine the relative condition of the vehicle 150. For example, if there are large-sized and/or a high number of differences between vehicle 150 and the vehicle reference, the condition of the vehicle may be considered to be lower than a vehicle having fewer such differences. In some embodiments according to the present disclosure, certain differences may be weighted more heavily in the evaluation of the relative condition of vehicle 150. For example, differences in the shape of a front or rear bumper may indicate more substantial damage than differences in the surfaces of the seating, or single large differences may be weighted more heavily than multiple smaller such differences. The relative condition of vehicle 150 may be expressed in a number of ways, including a percentage (e.g., vehicle 150 is an 85% match to the vehicle reference), a cost to repair (e.g., vehicle 150 exhibits differences that would cost approximately $1000 to repair), and/or a grade (e.g., vehicle 150 is a B+ example of the vehicle reference).

At step 260, system server 110 can retrieve a target vehicle reference from, for example, institutional database 120. Similar to the vehicle reference for vehicle 150, the target vehicle reference may be based on an identification of the vehicle, and other vehicle information such as the mileage, features, and options of the target vehicle. In some embodiments, some or all of the target vehicle information may be included in the initial request for a target vehicle value estimate, and any information not previously provided may be requested from the user via user device 140. Once the target vehicle has been identified, system server 110 may retrieve an appropriate vehicle reference for the target vehicle, for example, the closest vehicle reference available from institutional database 120 or other appropriate repository of vehicle data. As with the vehicle reference for vehicle 150, the target vehicle reference may include data that is an optical scan of a version of the target vehicle (e.g., a target reference vehicle of the same make, model, and year), or is similar to the data that would be in an optical scan of the target vehicle (e.g., a machine generated scan or model).

At step 270, system server 110 may generate a projection of the target vehicle by adjusting the relative condition of the target vehicle reference to reflect the estimated wear and/or damage of the indicated future use. For example, if vehicle 150 was evaluated to have been corroded by road salt (as cars in colder climates may be), a level of similar corrosion that corresponds to the intended period of use (e.g., the user requested a projected value based on three years of target vehicle ownership) could be applied to the target vehicle reference. In some embodiments, similarly to how machine learning systems may be used in determining the condition of vehicle 150, machine learning models may be applied to project the condition of the target vehicle. Whereas the comparison and evaluation of the vehicle scan and the vehicle reference were compared to assess the condition of the scanned vehicle 150, in this instance, the machine learning model would function to start with a target vehicle reference and then modify (e.g., deteriorate/age) the target vehicle reference according to the previously evaluated condition of vehicle 150. Such a model could be trained using data sets that include optical scans of various vehicles being used, for example, in known locations (e.g., a location that may have salted roads or hail storms), for known purposes (e.g., vehicles being used for work, commuting, and/or pleasure), or based on demographic similarities of the operator (e.g., pet owners or parents with small children).

System server 110 may also account for the mileage that would be estimated to be put on the target vehicle over the period of use. For example, a user having put 10,000 miles per year of ownership on vehicle 150, a similar rate of mileage can be applied to the target vehicle reference. By considering the relative condition of vehicle 150, the resulting projection of the future condition of the target vehicle can be tailored to a particular driver, driving style, location, or degree of care.

Having projected the condition of the target vehicle after the user's use, at step 280, system server 110 may proceed to retrieve third-party vehicle records relevant to the target vehicle, such as sales records concerning similar vehicles or sales records for vehicles in a particular area or region. This information may take the form of a collection of third-party vehicle records stored in, for example, institutional database 120. System server 110 may select, from the collection, a number of relevant third-party vehicle records that could provide a basis for valuing the target vehicle, at step 290. Based on the projected future condition of the target vehicle and the third-party vehicle records, system server 110, institutional database 120, or another analysis element, such as a machine learning system, may estimate the future value of the target vehicle. For example, a target vehicle that is projected to be in excellent condition, and be used sparingly over a two year period, may be valued based on a below average amount of depreciation as compared to vehicles used more frequently and less carefully.

In some embodiments in accordance with the present disclosure, steps 280 and 290 can be performed through the creation of a vehicle value model that directly or indirectly incorporates third-party vehicle records, for example, using machine learning techniques. Such a model could then be applied to the projection of the future condition of the target vehicle to determine an estimated value.

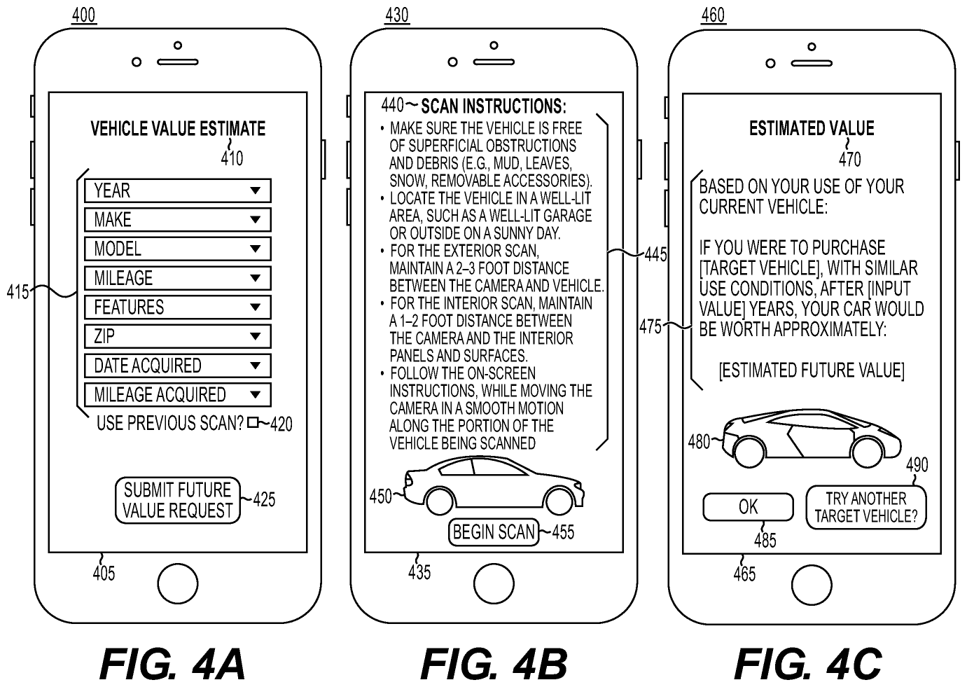

Because a user may be providing information for the initial request, performing the optical scan, and desiring to review the determined estimated value, system server 110 may communicate with the user via user device 140. To facilitate this interaction, one or more graphical user interfaces may be employed to provide or collect information. FIGS. 4A-4C illustrate exemplary graphical user interfaces (GUIs) 400, 430, 460 that may be displayed on user device 140. GUIs 400, 430, 460 may, for example, represent the user interfaces used to submit a request, conduct a vehicle scan, and view the resulting estimated future value of the target vehicle.

For example, GUI 400 may represent an exemplary user interface that a user may see when initiating a request for a target vehicle value estimate. GUI 400 may have a window 405 (e.g., a browser displayed webpage, whether on mobile or desktop device, or an application interface, whether on a mobile or desktop device) that includes the graphical elements that allow the user to interact with GUI 400 to submit a request. Heading text 410 can identify GUI 400 as an interface with which the user may request a vehicle value estimate, so as to distinguish it from other GUIs associated with this or other systems, websites, and applications. Below heading text 410, GUI 400 may include a series of input elements, such as drop down menus and text/number entry elements 415. These text/number entry elements 415 may enable the user to provide system server 110 with information regarding the vehicle to be scanned and/or information regarding the target vehicle. As discussed above, this information may include, for example, the year, make, model, mileage, features, zip code, date the vehicle was acquired, and mileage of the vehicle when acquired. In some embodiments the information collected via GUI 400 and text/number entry elements 415 may further include similar information about the target vehicle and the parameters of the request, such as how far into the future the user would like the projection to go, and the like. The information collected by GUI 400 may, at least in part, allow system server 110 to generate the vehicle reference and/or the target vehicle reference.

In some circumstances, the user may have previously scanned vehicle 150. When a scan has already been conducted, the user may indicate that they wish to reuse a previous scan as opposed to being instructed to perform a new vehicle scan by checking box 420. When box 420 is checked prior to the user tapping, clicking, or otherwise selecting element 425 to submit the future value request, system server 110 may then proceed to locate the previous scan to be used for the analysis (e.g., by using a last scan or selecting a scan in accordance with a user indication). However, when no scan has previously been performed or a scan that was performed is not recent enough to allow system server 110 to evaluate the current condition of vehicle 150, GUI 400 may progress to GUI 430.

GUI 430 may have a window 435 that includes the graphical elements that allow the user to interact with GUI 430 to begin an optical scan of vehicle 150. Heading text 440 can identify GUI 430 as an interface that provides the user with vehicle scanning instructions 445, prior to or during the performance of the optical scan. Vehicle scanning instructions 445 may be used to convey guidelines to aid the user in performing a scan having an appropriate amount of detail and substance. For example, vehicle scanning instructions 445 may include instructions relating to pre-scan preparation of vehicle 150 (e.g., the removal of debris, guidance on appropriate lighting conditions), instructions for performing the scan (e.g., how fast to move the optical sensor, how the optical sensor should be positioned), and instructions tailored to remedying deficiencies in the scanning process (e.g., an instruction to move the optical sensor closer or further from the vehicle, an instruction to move the optical sensor more slowly).

In some embodiments of GUI 430, a graphic element 450 may be provided to serve as an avatar for vehicle 150. This element can notify the user of the vehicle identified in the scan request, and may be used during the scan process to indicate particular areas of concern or to further guide and instruct the user. Having reviewed the instructions, and confirmed that graphic element 450 reflects the vehicle 150 to be scanned, the user may tap, click, or otherwise select element 455 to begin the vehicle scanning process. In some embodiments, the GUI displayed during the performance of the vehicle scan may provide one or more of: reflecting the optical scan as it is being captured, providing additional instructions, and/or keeping track of the areas and surfaces of vehicle 150 that have or have not been scanned.

Once the scan has been performed (including using a previous scan), GUI 460 may communicate the estimated future value to the user in response to the request. GUI 460 may include a window 465 within which one or more elements may be displayed to provide the estimated future value to the user. For example, heading text 470 may be included to convey that GUI 460 is providing the estimated value of the target vehicle, while text 475 may provide the user with a concise explanation of the assumptions made, as well as the conclusion regarding the future estimated value of the target vehicle. Graphic element 480 may be provided to serve as an avatar for the target vehicle so that the user is aware of the target vehicle to which the estimate refers. In some embodiments, graphic element 480 may be a version of the target vehicle that visually reflects the projected condition (e.g., illustrating the damage and wear projected for the target vehicle). As a user may be deciding between vehicles to purchase, and thus may be projecting multiple target vehicles, the inclusion of graphic element 480 may ensure that the user is clear, even at a glance, which target vehicle value projection is depicted.

In some embodiments, once the user has been able to review the information provided by GUI 460, one or more elements may be provided to allow the user to proceed from window 465 on to another task. For example, they may select element 485 to close out of window 465 and continue on to another task, or they may select element 490 to automatically proceed to selecting a different target vehicle. Element 490 may direct the user to a GUI that allows the user to input target vehicle information for another vehicle, without the need for re-entering the information related to scanned vehicle 150. In some embodiments, system server 110 may provide for the storage of multiple target vehicle value estimates to allow the user to compare how the value of different target vehicles may be projected based on the user's use of their current vehicle 150.

Methods and systems in accordance with this disclosure may provide future value estimates for target vehicles that take into account the use patterns and conditions of the operator of a current vehicle, and by doing so may provide future condition and value estimates tailored to the circumstances and patterns of use exhibited by a particular vehicle operator. Providing the user with one or more projections of how their operation of a vehicle considered for purchase may impact its future value may enable the user to spend fewer resources during the decision making process while the user may be more confident in their choice of vehicle. Users may also be able to take appropriate precautions in advance, for example, selecting insurance to cover likely wear or choosing an options package with features aimed at increasing durability. Further, institutions (such as those that provide vehicle financing) may be capable of using these estimated future values of the target vehicle when considering a prospective purchaser of a vehicle.

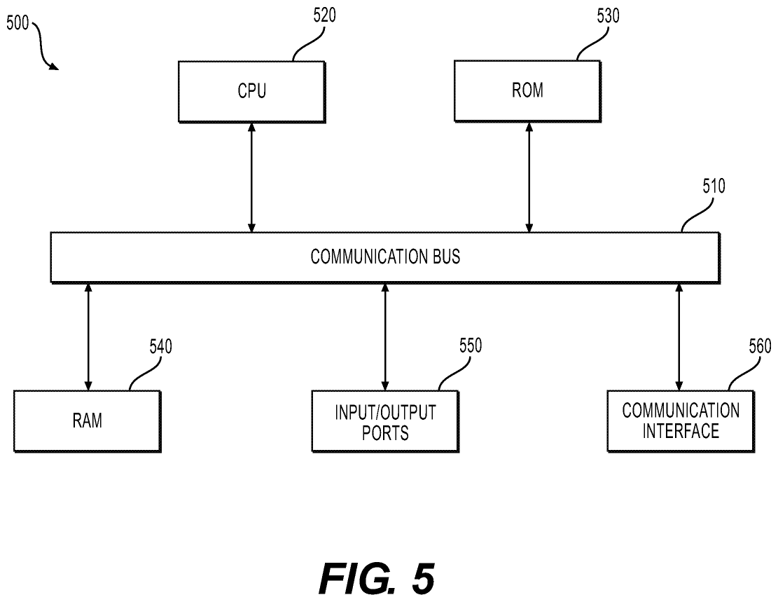

FIG. 5 depicts an example system 500 that may execute techniques presented herein. FIG. 5 is a simplified functional block diagram of a computer that may be configured to execute techniques described herein, according to exemplary embodiments of the present disclosure. Specifically, the computer (or “platform” as it may not be a single physical computer infrastructure) may include a data communication interface 560 for packet data communication. The platform may also include a central processing unit (CPU) 520, in the form of one or more processors, for executing program instructions. The platform may include an internal communication bus 510, and the platform may also include a program storage and/or a data storage for various data files to be processed and/or communicated by the platform such as ROM 530 and RAM 540, although the system 500 may receive programming and data via network communications. The system 500 also may include input and output ports 550 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be encoded, stored, and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for estimating a value of a future vehicle comprising:
receiving a request for a target vehicle value estimate for a target vehicle, wherein the request includes a mileage of a first vehicle and a feature set of the first vehicle;
obtaining an optical scan corresponding to the first vehicle, wherein the optical scan is performed by an optical sensor and includes a digital surface representation of at least one surface of the first vehicle;
generating a first vehicle reference based on at least an identification of the first vehicle, the mileage of the first vehicle, and the feature set of the first vehicle;
comparing the optical scan to the first vehicle reference to identify one or more differences between the at least one surface of the first vehicle and a corresponding surface of the first vehicle reference that are indicative of damage or wear;
at least partly based on the one or more differences indicative of damage or wear, evaluating a relative condition of the first vehicle;
retrieving a target vehicle reference, wherein the target vehicle reference corresponds to the target vehicle identified in the request for the target vehicle value estimate;
generating, based at least in part on the relative condition of the first vehicle, a projection of a future condition of the target vehicle;
retrieving third-party vehicle records relevant to the target vehicle; and
determining, based on the third-party vehicle records, an estimated future value of the target vehicle.

2. The method of claim 1, wherein the mileage of the first vehicle includes at least a duration of use and a distance of use.

3. The method of claim 1, wherein the optical scan is received from the optical sensor associated with a user device.

4. The method of claim 3, further including:
in response to receiving the request for the target vehicle value estimate, providing scan instructions to the user device to guide a user in performing the optical scan of the first vehicle.

5. The method of claim 4, further including:
validating the optical scan to determine if it contains sufficient detail for evaluating the relative condition of the first vehicle; and
in response to a lack of validation of the optical scan, providing additional scan instructions to the user device to guide the user in performing additional scanning of the first vehicle.

6. The method of claim 1, wherein the request for the target vehicle value estimate further includes the identification of the first vehicle.

7. The method of claim 1, wherein the identification of the first vehicle is determined by:
comparing one or more features from the optical scan with a database of vehicle information; and
determining, based at least in part on the comparison, the identification of the first vehicle.

8. The method of claim 1, wherein the first vehicle reference is generated based on at least one reference scan of a first reference vehicle.

9. The method of claim 8, wherein the target vehicle reference is generated based on at least one reference scan of a target reference vehicle.

10. The method of claim 1, wherein the projection of the future condition of the target vehicle is based at least in part on demographic information related to an operator of the first vehicle.

11. A system for estimating a value of a future vehicle comprising:
a processor; and
a memory storing instructions that, when executed by the processor, cause the processor to perform operations including:
receiving a request for a target vehicle value estimate for a target vehicle, wherein the request includes a mileage of a first vehicle and a feature set of the first vehicle;
obtaining an optical scan corresponding to the first vehicle, wherein the optical scan is performed by an optical sensor and includes a digital surface representation of at least one surface of the first vehicle;
generating a first vehicle reference based on at least an identification of the first vehicle, the mileage of the first vehicle, and the feature set of the first vehicle;
comparing the optical scan to the first vehicle reference to identify one or more differences between the at least one surface of the first vehicle and a corresponding surface of the first vehicle reference that are indicative of damage or wear;
at least partly based on the one or more differences indicative of damage or wear, evaluating a relative condition of the first vehicle;
retrieving a target vehicle reference, wherein the target vehicle reference corresponds to the target vehicle identified in the request for the target vehicle value estimate;
generating, based at least in part on the relative condition of the first vehicle, a projection of a future condition of the target vehicle;
retrieving third-party vehicle records relevant to the target vehicle; and
determining, based on the third-party vehicle records, an estimated future value of the target vehicle.

12. The system of claim 11, wherein the mileage of the first vehicle includes at least a duration of use and a distance of use.

13. The system of claim 11, wherein the optical scan is received from the optical sensor associated with a user device.

14. The system of claim 13, wherein the operations further include:
in response to receiving the request for the target vehicle value estimate, providing scan instructions to the user device to guide a user in performing the optical scan of the first vehicle.

15. The system of claim 14, wherein the operations further include:
validating the optical scan to determine if it contains sufficient detail for evaluating the relative condition of the first vehicle; and
in response to a lack of validation of the optical scan, providing additional scan instructions to the user device to guide the user in performing additional scanning of the first vehicle.

16. The system of claim 11, wherein the request for the target vehicle value estimate further includes the identification of the first vehicle.

17. The system of claim 11, wherein the identification of the first vehicle is determined by:
comparing one or more features from the optical scan with a database of vehicle information; and
determining, based at least in part on the comparison, the identification of the first vehicle.

18. The system of claim 11, wherein the first vehicle reference is generated based on at least one reference scan of a first reference vehicle.

19. The system of claim 11, wherein the projection of the future condition of the target vehicle is based at least in part on demographic information related to an operator of the first vehicle.

20. A non-transitory computer-readable medium may store instructions that, when executed by a processor, cause the processor to perform a method, the method comprising:
receiving a request for a target vehicle value estimate for a target vehicle, wherein the request includes a mileage of a first vehicle and a feature set of the first vehicle;
providing scan instructions to a user device to guide a user in performing an optical scan of the first vehicle;
obtaining the optical scan corresponding to the first vehicle, wherein the optical scan is performed by an optical sensor and includes a digital surface representation of at least one surface of the first vehicle;
generating a first vehicle reference based on at least an identification of the first vehicle, the mileage of the first vehicle, the feature set of the first vehicle, and at least one reference scan of a first reference vehicle;
comparing the optical scan to the first vehicle reference to identify one or more differences between the at least one surface of the first vehicle and a corresponding surface of the first vehicle reference that are indicative of damage or wear;
at least partly based on the one or more differences indicative of damage or wear, evaluating a relative condition of the first vehicle;
retrieving a target vehicle reference, wherein the target vehicle reference corresponds to the target vehicle identified in the request for the target vehicle value estimate;
generating, based at least in part on the relative condition of the first vehicle, a projection of a future condition of the target vehicle;
retrieving third-party vehicle records relevant to the target vehicle; and
determining, based on the third-party vehicle records, an estimated future value of the target vehicle.
